(19) United States
(12) Patent Application Publication
(10) Pub. No.: US 2026/0015263 A1
(43) Pub. Date: Jan. 15, 2026

(54) ULTRAPURE WATER PRODUCTION APPARATUS AND ULTRAPURE WATER PRODUCTION METHOD

(71) Applicant: ORGANO CORPORATION, Tokyo (JP)

(72) Inventors: Fumitaka ICHIHARA, Tokyo (JP); Keisuke SASAKI, Tokyo (JP); Tsukasa KONDO, Tokyo (JP)

(73) Assignee: ORGANO CORPORATION, Tokyo (JP)

(21) Appl. No.: 19/108,508

(22) PCT Filed: Aug. 4, 2023
(86) PCT No.: PCT/JP2023/028559

§ 371 Date: Mar. 4, 2025

(30) Foreign Application Priority Data
Sep. 6, 2022 (JP) 2022-141520

(51) Int. Cl. C02F 1/32; B01D 61/48; B01D 61/58; C02F 1/44; C02F 1/469; C02F 1/70; C02F 103/04

(52) U.S. Cl. CPC C02F 1/32; B01D 61/48; B01D 61/58; C02F 1/444; C02F 1/4695; C02F 1/70; C02F 2103/04; C02F 2201/4617; C02F 2209/30

(57) ABSTRACT

An ultrapure water production apparatus includes: a receiving unit that accepts water to be treated; a first pump that feeds the water to be treated; an ultraviolet irradiation device at a secondary side of the first pump to perform ultraviolet oxidation treatment; an oxidizing substance removal device remove at least oxidizing substances from the outlet water of the ultraviolet irradiation device; and a second pump installed at a subsequent stage of the oxidizing substance removal device to feed outlet water of the oxidizing substance removal device as ultrapure water. At least a portion of the ultrapure water produced is circulated to receiving unit. The oxidizing substance removal device includes a chamber positioned between an anode and a cathode, and filled with an ion exchanger. At least a portion of the ion exchanger is an ion exchanger on which a metal catalyst is supported.

### TECHNICAL FIELD

The present invention relates to a device and method for producing ultrapure water, and in particular, to an ultrapure water production apparatus and an ultrapure water production method for producing ultrapure water in which the concentration of oxidizing substances such as dissolved oxygen is reduced.

### BACKGROUND ART

Ultrapure water, from which impurities are highly removed, is widely used in applications such as cleaning of silicon wafers in semiconductor manufacturing processes. In general, ultrapure water is produced by using river water, well water, industrial water, etc. as raw water, producing primary pure water by sequentially treating the raw water with a pretreatment system and a primary pure water system, and further treating this primary pure water with a subsystem. The subsystem is also called a secondary pure water system. The subsystem produces ultrapure water by sequentially treating the primary pure water, which is the water to be treated, and supplies the ultrapure water to a point of use. Ultrapure water that has not been supplied to the point of use is returned to the inlet side of the subsystem, which allows water to circulate within the subsystem.

Many subsystems are equipped with a membrane degassing device to remove dissolved oxygen (DO) contained in the water to be treated, i.e., primary pure water. Membrane degassing devices are installed in subsystems, for example, between the outlet of an ultraviolet irradiation device and the inlet of a non-regenerative ion exchange device, or at the subsequent stage of the non-regenerative ion exchange device. In the membrane degassing device, it is necessary to maintain a degree of vacuum on the gas phase side, which is the opposite side of the water to be treated across a degassing membrane, and a vacuum pump or the like must be installed for this purpose. As a method for removing dissolved oxygen without membrane degassing, Patent Literature 1, for example, discloses a method for removing dissolved oxygen in which a reducing agent such as hydrogen is added to the water to be treated, which is then brought into contact with a metal-supported catalyst on which a metal such as palladium is supported, and reaction that generates water from dissolved oxygen and hydrogen proceeds as shown in the following formula (1) to remove dissolved oxygen in the water to be treated.

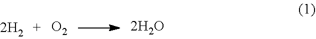

Similarly, as a method for removing dissolved oxygen in a subsystem, Patent Literature 2 discloses that a noble metal catalyst-filled container filled with a noble metal catalyst in which hydrogen is absorbed in advance is placed at a subsequent stage of an ultraviolet oxidation device in the subsystem. In the method of removing dissolved oxygen in the water to treated by adding hydrogen to the water to be treated and then reacting dissolved oxygen with hydrogen on a catalyst, the dissolved hydrogen (DH) concentration in the treated water may become high if the amount of hydrogen added is not appropriate. Patent Literature 3, therefore, describes an oxidizing substance removal device for removing at least one of dissolved oxygen and hydrogen peroxide from water to be treated, including: a catalytic reaction device equipped with a platinum group metal-supported catalyst; a hydrogen adding device installed at a preceding stage of the catalytic reaction device to add hydrogen to the water to be treated; a concentration measuring means for measuring the concentration of dissolved hydrogen in the water to be treated that is just passing through the catalytic reaction device; and a control means for adjusting the amount of hydrogen added in the hydrogen adding device based on the measured dissolved hydrogen concentration.

By the way, as one of devices that generate deionized water from water to be treated, there is an electrodeionization (EDI) device. The EDI device is a device in which electrophoresis and electrodialysis are combined, and at least the deionization chamber thereof is filled with an ion exchanger such as an ion exchange resin. The EDI device has advantages that it does not need a treatment of regenerating the ion exchange resin by chemicals. To reduce the dissolved oxygen concentration in the deionized water produced by the EDI device, Patent Literature 4 discloses that an anion exchange resin and a cation exchange resin are mixed and filled in the deionization chamber of an EDI device, a part of the anion exchange resin being a catalytic resin on which cupper or palladium are supported, and that hydrogen is added to water to be treated supplied to the deionization chamber to perform, in the deionization chamber, deionization of the water to be treated and removal of dissolved oxygen from the water to be treated. Since cathode water discharged from the cathode chamber of an EDI device generally contains hydrogen, Patent Literature 4 also discloses that the cathode water is used as a hydrogen source and added to the water to be treated.

### CITATION LIST

### Patent Literatures

Patent Literature 1: JP 2010-240642 A
Patent Literature 2: JP 2016-112532 A
Patent Literature 3: JP 2015-166064 A
Patent Literature 4: JP H10-272474 A

### SUMMARY OF INVENTION

### Technical Problem

The techniques described in Patent Literatures 1 and 3 require a hydrogen adding device used only for removing dissolved oxygen, and the technique described in Patent Literature 2 requires the preparation of a noble metal catalyst that has absorbed hydrogen in advance. If these techniques are applied to ultrapure water production systems, ancillary equipment in the ultrapure water production systems will increase, causing an increase in initial costs and installation space. The technique described in Patent Literature 4, which attempts to reduce the concentration of dissolved oxygen in deionized water when the deionized water is generated by an EDI device, is intended to reduce the concentration of dissolved oxygen in the deionized water to several tens of μg/L. This technique described in Patent Literature 4 cannot be applied to ultrapure water production, which requires a greater reduction in dissolved oxygen concentration, as is.

In ultrapure water production systems, it is desirable to reduce the concentration of dissolved oxygen in the ultrapure water, which is the treated water, as much as possible, and it is also necessary to control the concentration of dissolved hydrogen in the treated water to a low level. The concentration of dissolved hydrogen required to remove dissolved oxygen is ⅛ of the dissolved oxygen concentration on a mass basis, based on stoichiometry. When producing ultrapure water with a dissolved oxygen concentration of less than 1 μg/L by removing a few μg/L of dissolved oxygen contained in water to be treated, it is necessary to control the concentration of dissolved hydrogen in extremely minute amounts. However, it is unclear whether it is possible to control the dissolved hydrogen concentration at such a trace level or to control the hydrogen addition amount at such a trace level. It is also desirable to reduce a concentration of hydrogen peroxide, which is inevitably generated in the process of producing ultrapure water.

The object of the present invention is to provide an ultrapure water production apparatus and ultrapure water production method that can efficiently remove oxidizing substances such as trace amounts of dissolved oxygen contained in water to be treated, and can also easily control the dissolved hydrogen concentration to stably obtain good treated water quality.

### Solution to Problem

The ultrapure water production apparatus according to one aspect of the present invention is an ultrapure water production apparatus that sequentially treats water to be treated to produce ultrapure water, including: a receiving unit that accepts the water to be treated; a first pump connected to an outlet of the receiving unit to feed the water to be treated; an ultraviolet irradiation device that is installed at a secondary side of the first pump, and irradiates the water to be treated with ultraviolet light to perform ultraviolet oxidation treatment; an oxidizing substance removal device that is installed at a subsequent stage of the ultraviolet irradiation device and removes at least oxidizing substances contained in the water to be treated; and a second pump installed at a subsequent stage of the oxidizing substance removal device to feed outlet water of the oxidizing substance removal device, wherein at least a portion of ultrapure water produced is circulated to the receiving unit. Here, the oxidizing substance removal device includes: an anode and a cathode; a dissolved oxygen removal chamber which is positioned between the anode and the cathode, and filled with an ion exchanger, and through which the water to be treated passes; and a power supply unit that applies a DC current between the anode and the cathode, wherein at least a portion of the ion exchanger filled in the dissolved oxygen removal chamber is an ion exchanger on which a metal catalyst is supported.

The ultrapure water production method according to one aspect of the present invention is an ultrapure water production method for producing ultrapure water by sequentially treating water to be treated, including a first pressurization step to pressurize and feed the water to be treated; an ultraviolet irradiation step to irradiate the water to be treated which is fed by the first pressurization step with ultraviolet light to perform ultraviolet oxidation treatment; an oxidizing substance removal step to remove at least oxidizing substances contained in outlet water of the ultraviolet irradiation step; a second pressurization step to pressurize and feed outlet water of the oxidizing substance removal step; and a step of circulating at least a portion of produced ultrapure water to a preceding stage of the ultraviolet irradiation process step. Here, the oxidizing substance removal step includes: a step of applying a DC current between the anode and cathode; and a step of passing the water to be treated through a dissolved oxygen removal chamber, which is located between the anode and the cathode and filled with an ion exchanger, wherein at least a portion of the ion exchanger filled in the dissolved oxygen removal chamber is an ion exchanger on which a metal catalyst is supported.

In the ultrapure water production apparatus of the one aspect, dissolved oxygen in the water to be treated is removed in the dissolved oxygen removal chamber of the oxidizing substance removal device. Dissolved oxygen can be removed in the dissolved oxygen removal chamber because dissolved oxygen reacts with hydrogen in the presence of a metal catalyst to form water. Therefore, unless the water to be treated introduced into the dissolved oxygen removal chamber originally contains hydrogen, hydrogen must be generated in the dissolved oxygen removal chamber or hydrogen must be added to the water to be treated upstream of the dissolved oxygen removal chamber. By the way, the oxidizing substance removal device has a configuration basically similar to a general EDI device, except that it is configured to remove oxidizing substances such as dissolved oxygen, etc. In the cathode chamber of an EDI device, hydrogen is generated by a cathodic reaction on the cathode surface, the water to be treated containing hydrogen can be supplied to the dissolved oxygen removal chamber by diverting a portion of the water to be treated supplied to the oxidizing substance removal device to the cathode chamber, and merging the outlet water of the cathode chamber with the water to be treated introduced into the dissolved oxygen removal chamber. Alternatively, the cathode chamber itself can be used as a dissolved oxygen removal chamber. The dissolved oxygen removal chamber can also be used to remove oxidizing substances other than dissolved oxygen. Depending on the type of oxidizing substance, hydrogen may not be required for the removal of that oxidizing substance and therefore the water to be treated introduced into the dissolved oxygen removal chamber may not need to contain hydrogen.

The reaction rate of the reaction between dissolved oxygen and hydrogen in the presence of a metal catalyst is large, and it can be considered that an amount of dissolved oxygen equivalent to the amount of hydrogen contained in the water to be treated is removed in the dissolved oxygen removal chamber. Therefore, by measuring the concentration of dissolved hydrogen in the treated water flowing out of the dissolved oxygen removal chamber and increasing the amount of hydrogen added to the water to be treated within the range where the concentration of dissolved hydrogen in the treated water does not increase, the concentration of dissolved oxygen in the treated water can be reduced to the limit and the dissolved hydrogen concentration in the treated water can be controlled. When hydrogen is generated in the cathode chamber and the water to be treated with which the outlet water of the cathode chamber is merged is introduced into the dissolved oxygen removal chamber, the concentration of dissolved oxygen in the treated water can be reduced to the limit while managing the dissolved hydrogen concentration in the treated water, by controlling the DC current applied between the anode and cathode of the oxidizing substance removal device in accordance with the dissolved hydrogen concentration in the treated water.

In the present invention, any catalyst that promotes the reaction of generating water from hydrogen and oxygen can be used as the metal catalyst supported on the ion exchanger that is filled in the dissolved oxygen removal chamber. Examples of such metal catalysts include iron, copper, manganese, palladium, platinum, etc. Among them, platinum group metal catalysts are suitable for use when hydrogen peroxide is contained in the water to be treated, because they not only promote the reduction reaction of oxygen but also have high catalytic activity for hydrogen peroxide decomposition. The platinum group metal catalysts are catalysts containing one or more metals selected from ruthenium, rhodium, palladium, osmium, iridium, and platinum. A platinum group metal catalyst may contain any of these metal elements alone or a combination of two or more of them. Among these, platinum, palladium, and platinum-palladium alloy have high catalytic activity and are suitably used as the platinum group metal catalysts.

The oxidizing substance removal device is typically designed so that oxidizing substances such as dissolved oxygen can be removed in the deionization chamber of an EDI device. As described below, hydrogen peroxide, an oxidizing substance, can also be removed by the oxidizing substance removal device. Therefore, it is preferable that the dissolved oxygen removal chamber is partitioned by an ion exchange membrane. Due to the oxidizing substance removal chamber partitioned by an ion exchange membrane, it is possible to efficiently perform deionization treatment of the water to be treated in the dissolved oxygen removal chamber. Alternatively, the anode chamber or the cathode chamber of the EDI device can be used as the dissolved oxygen removal chamber, in which case the dissolved oxygen removal chamber is partitioned by an electrode plate that is the anode or another electrode plate that is the cathode.

### Advantageous Effects of Invention

According to the present invention, in the production of ultrapure water, oxidizing substances such as dissolved oxygen in trace amounts contained in the water to be treated can be efficiently removed, and the concentration of dissolved hydrogen can also be easily controlled to obtain good treated water quality in a stable manner.

### BRIEF DESCRIPTION OF DRAWINGS

FIG. 1 is a flow sheet showing an example of the configuration of an ultrapure water production system;

FIG. 2 is a view showing an example of the configuration of a dissolved oxygen removal device;

FIG. 3 is a flow sheet showing another example of the configuration of the ultrapure water production system;

FIG. 4 is a view showing another example of the configuration of the dissolved oxygen removal device;

FIG. 5 is a view showing another example of the configuration of the dissolved oxygen removal device;

FIG. 6 is a view showing another example of the configuration of the dissolved oxygen removal device;

FIG. 7 is a view showing another example of the configuration of the dissolved oxygen removal device;

FIG. 8 is a view showing another example of the configuration of the dissolved oxygen removal device;

FIG. 9 is a view showing another example of the configuration of the dissolved oxygen removal device;

FIG. 10 is a view showing another example of the configuration of the dissolved oxygen removal device;

FIG. 11 is a view showing another example of the configuration of the dissolved oxygen removal device;

FIG. 12 is a view showing the configuration of the dissolved oxygen removal device used in Example 1;

FIG. 13 is a graph showing the results obtained in Example 1; and

FIG. 14 is a view showing the configuration of the dissolved oxygen removal device used in Example 2.

### DESCRIPTION OF EMBODIMENTS

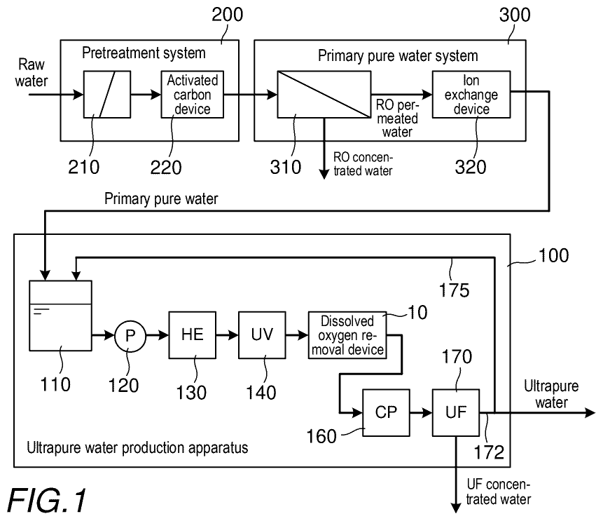

Next, embodiments for implementing the present invention will be described. The ultrapure water production apparatus based on the present invention is used as a subsystem in an ultrapure water production system that produces ultrapure water from raw water such as industrial water, well water, river water, etc. FIG. 1 shows the configuration of an ultrapure water production system in which ultrapure water production apparatus 100 according to an embodiment is incorporated.

The ultrapure water production system shown in FIG. 1 is equipped with: pretreatment system 200 that accepts raw water and performs pretreatment; primary pure water system 300 that treats the pretreated raw water to produce primary pure water; and ultrapure water production apparatus 100 according to the present embodiment as a subsystem that accepts the primary pure water produced by primary pure water system 300 to produce ultrapure water. Pretreatment system 200 is equipped with: filter 210; and activated carbon (AC) device 220, and the raw water is treated in this order. Primary pure water system 300 is equipped with: reverse osmosis membrane device (RO) 310 to which the raw water discharged from activated carbon device 220 of pretreatment system 200 is supplied; and ion exchange device 320 to which the permeated water (RO permeated water) from reverse osmosis membrane device 310 is supplied. Primary pure water is obtained from ion exchange device 320. Reverse osmosis membrane device 310 discharges concentrated water (RO concentrated water) in addition to the permeated water. The configurations of pretreatment system 200 and primary pure water system 300 described here are only examples, and any known configuration for producing primary pure water can be used in the present embodiment.

Ultrapure water production apparatus 100 is equipped with primary pure water tank 110 that serves as a receiving unit for primary pure water supplied from the primary pure water system. Ultrapure water production apparatus 100 uses the water in primary pure water tank 110 as water to be treated, and performs sequential treatment for this water to be treated to produce ultrapure water. At the outlet of primary pure water tank 110, pump 120 that pressurizes and feeds the water in primary pure water tank, i.e., the water to be treated, is provided. On the secondary side of pump 120, provided in the following order are: heat exchanger (HE) 130; ultraviolet irradiation device (UV) 140; dissolved oxygen removal device 10 configured as an oxidizing substance removal device according to the present invention; a non-regenerative ion exchange device (CP) 160, also called a cartridge polisher, etc.; and ultrafiltration membrane device (UF) 170. Ultraviolet irradiation device 140 irradiates the water to be treated with ultraviolet light to performs ultraviolet oxidation treatment. Dissolved oxygen removal device 10 removes at least oxidizing substances contained in the water to be treated after the ultraviolet oxidation treatment. Typical oxidizing substances to be removed are dissolved oxygen. Dissolved oxygen removal device 10 is described below.

Non-regenerative ion exchange device (CP) 160 removes ionic impurities contained in the treated water of dissolved oxygen removal device 10, and ultrafiltration membrane device 170 removes particulates contained in the outlet water of non-regenerative ion exchange device (CP) 160. The outlet water, which is the permeated water of ultrafiltration membrane device 170, is ultrapure water, and pipe 172 for supplying this ultrapure water to the point od use is connected to the outlet of ultrafiltration membrane device 170. In addition, circulation pipe 175 for returning the ultrapure water to primary pure water tank 110 branches off from pipe 172. Since ultrafiltration membrane device 170 is a cross-flow type filtration device, concentrated water (UF concentrated water) is also discharged from ultrafiltration membrane system 170.

Ultrapure water production apparatus 100 shown in FIG. 1 has the same structure as a general subsystem for producing ultrapure water from primary pure water, except that a membrane degassing device is not provided and dissolved oxygen removal device 10 is installed. Therefore, by supplying primary pure water to primary pure water tank 110 and operating pump 120, the primary pure water, which is the water to be treated, passes through heat exchanger 130, ultraviolet irradiation device 140, dissolved oxygen removal device 10, non-regenerative ion exchange device 160, and ultrafiltration membrane device 170 in this order and is treated sequentially. As a result, ultrapure water is obtained as the permeated water from ultrafiltration membrane device 170. At least a portion of the ultrapure water produced is then returned to primary pure water tank 110 via circulation pipe 175. In this way, the water to be treated circulates inside ultrapure water production apparatus 100, and as it circulates, its purity as ultrapure water is further improved. Since dissolved oxygen removal device 10 also has a deionization function, as described below, it is possible to configure ultrapure water production apparatus 10 shown in FIG. 1 without non-regenerative ion exchange device 160.

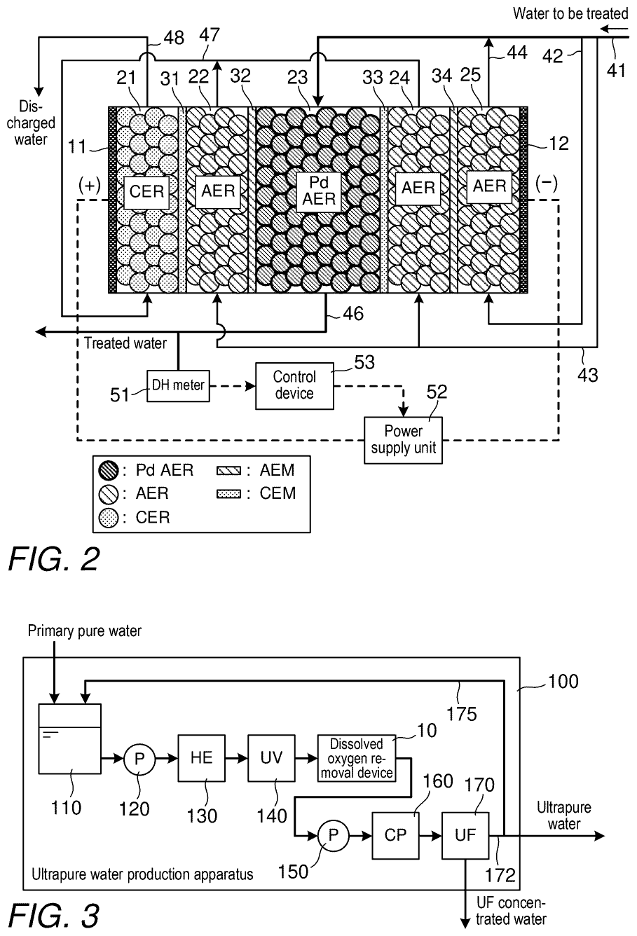

Next, dissolved oxygen removal device 10, which is an oxidizing substance removal device configured based on the present invention, will be described using FIG. 2. Dissolved oxygen removal device 10 has a function of removing oxidizing substances from water to be treated, and removes, for example, dissolved oxygen in the water to be treated. Since hydrogen peroxide is generated in the ultraviolet oxidation treatment, dissolved oxygen removal device 10 installed at a subsequent stage of ultraviolet irradiation device 140 also removes hydrogen peroxide, which is an oxidizing substance. As shown in FIG. 2, dissolved oxygen removal device 10 is equipped with: anode chamber 21 in which anode 11 is provided; and cathode chamber 25 in which cathode 12 is provided, as in a general EDI device. Concentration chamber 22, dissolved oxygen removal chamber 23, and concentration chamber 24 are provided between anode chamber 21 and cathode chamber 25 in that order from the side of anode chamber 21. Anode chamber 21 and concentration chamber 22 are partitioned by cation exchange membrane 31 provided therebetween; concentration chamber 22 and dissolved oxygen removal chamber 23 are partitioned by anion exchange membrane 32 provided therebetween; dissolved oxygen removal chamber 23 and concentration chamber 24 are partitioned by cation exchange membrane 33 provided therebetween; and concentration chamber 24 and cathode chamber 25 are partitioned by anion exchange membrane 34 provided therebetween. Anode chamber 21 is filled with a cation exchange resin (CER), which is a cation exchanger, and concentration chambers 22, 24 and cathode chamber 25 are filled with an anion exchange resin (AER), which is an anion exchanger. Dissolved oxygen removal chamber 23 is filled with, in a single-bed manner, an ion exchanger with a surface on which a metal catalyst is supported. In the example shown in FIG. 2, an anion exchange resin with palladium (Pd) supported on its surface is filled in dissolved oxygen removal chamber 23 in a single-bed manner. In the following description, the anion exchange resin with palladium (Pd) supported on its surface is referred to as Pd-supported anion exchange resin (Pd AER). In FIG. 2, the piping used to distribute liquid is shown as solid lines, and the wiring used to apply DC current to electrodes 11, 12 and to transmit various signals is shown as dashed lines.

The water to be treated, which is the outlet water from ultraviolet irradiation device 140, is supplied to the inlet of dissolved oxygen removal chamber 23 via pipe 41. Branching off from pipe 41 are pipe 42, which supplies the water to be treated to cathode chamber 25, and pipe 43, which supplies the water to be treated to concentration chambers 22, 24 as concentration chamber supply water. The outlet water from cathode chamber 25 merges into the water to be treated flowing in pipe 41 via pipe 44, downstream from the position where pipe 42 branches off from pipe 41. Therefore, part of the water to be treated that is passed through dissolved oxygen removal chamber 23 is the water to be treated that has passed through cathode chamber 25. The entire amount of the water to be treated, excluding that supplied to concentration chambers 22, 24, may be introduced into dissolved oxygen removal chamber 23 after passing through cathode chamber 25. From dissolved oxygen removal chamber 23, treated water from which dissolved oxygen has been removed is discharged via pipe 46. The outlet water from concentration chambers 22, 24 is supplied to anode chamber 21 via pipe 47, and the outlet water from anode chamber 21 is discharged as waste water to the outside of dissolved oxygen removal device 10 via pipe 48.

Dissolved hydrogen concentration meter (DH meter) 51 for measuring the concentration of dissolved hydrogen in the treated water is connected to pipe 46 through which the treated water, which is the outlet water of dissolved oxygen removal chamber 23, flows. Dissolved oxygen removal device 10 is also equipped with: power supply unit 52 for applying a DC current between anode 11 and cathode 12; and control device 53 for controlling power supply unit 52. The measured values taken by dissolved hydrogen concentration meter 51 are sent to control device 53. Control device 53 controls power supply unit 52 so that the electric current flowing between anode 11 and cathode 12 is varied based on the measured values taken by dissolved hydrogen concentration meter 51, i.e., the dissolved hydrogen concentration in the treated water.

Next, the removal of dissolved oxygen in dissolved oxygen removal device 10 shown in FIG. 2 will be described. In a state where a DC current is applied between anode 11 and cathode 12 while concentration chambers 22, 24 are supplied with concentration chamber supply water, the water to be treated is supplied to dissolved oxygen removal chamber 23 and cathode chamber 25. In cathode chamber 25, the DC current causes a cathodic reaction to proceed on the surface of cathode 12 and to generate hydrogen (H₂). The water to be treated discharged from cathode chamber 25 as outlet water contains hydrogen. Since the outlet water from cathode chamber 25 merges into the water to be treated flowing in pipe 41 via pipe 44, hydrogen is added to the water to be treated which is introduced into dissolved oxygen removal chamber 23. This hydrogen may not only be dissolved in the water to be treated, but may also be dispersed in the water to be treated as minute bubbles. When the water to be treated thus containing hydrogen flows into dissolved oxygen removal chamber 23, dissolved oxygen in the water to be treated reacts with hydrogen on the surface of the Pd-supported anion exchange resin (Pd AER) packed in dissolved oxygen removal chamber 23 to generate water. The dissolved oxygen in the water to be treated decreases to the extent that hydrogen reacts with the dissolved oxygen, and the dissolved hydrogen also decreases. Since the reaction rate of hydrogen and oxygen is high in the presence of palladium, which is a metal catalyst, if a sufficient amount of hydrogen is contained in the water to be treated, the treated water from which dissolved oxygen is sufficiently removed is discharged from dissolved oxygen removal chamber 23. Since dissolved oxygen is removed if hydrogen is present in dissolved oxygen removal chamber 23, dissolved oxygen can also be removed even when the application of the DC current between anode 11 and cathode 12 is intermittent, considering the residence time of the water to be treated in dissolved oxygen removal chamber 23 and cathode chamber 25. More specifically, while the DC current is applied continuously or intermittently, the passage of the water to be treated into dissolved oxygen removal chamber 23 may also be performed intermittently.

Since the Pd-supported anion exchange resin is an anion exchanger, dissolved oxygen removal chamber 23 filled with the Pd-supported anion exchange resin functions in the same way as a deionization chamber in a general EDI device, and the deionization process for the water to be treated also proceeds in dissolved oxygen removal chamber 23. For example, anions such as carbonate ions (CO₃²⁻) and bicarbonate ions (HCO₃⁻) in the water to be treated are captured by the Pd-supported anion exchange resin. Since hydroxide ions (OH) are also generated by the dissociation of water on the surface of cation exchange membrane 33 facing dissolved oxygen removal chamber 23, anions captured in the Pd-supported anion exchange resin (Pd AER) are ion-exchanged and released by hydroxide ions, which are then moved by the electric field between anode 11 and cathode 12 and transferred into concentration chamber 22 through anion exchange membrane 32. The anions transferred to concentration chamber 22 are then discharged to the outside of the device through anode chamber 21 in the flow of supply water in concentration chamber 22.

The Pd-supported anion exchange resin can also decompose hydrogen peroxide, so hydrogen peroxide in the water to be treated is also removed in dissolved oxygen removal device 10, and ultrapure water production apparatus 100 in the present embodiment can remove hydrogen peroxide from the water to be treated. When the Pd-supported anion exchange resin decomposes hydrogen peroxide, the decomposition products are water and oxygen. Although the concentration of dissolved oxygen increases as oxygen is generated, the generated oxygen reacts with hydrogen in the presence of the Pd-supported anion exchange resin to form water, so there is no significant increase in the concentration of dissolved oxygen due to the decomposition and removal of hydrogen peroxide.

Ultrapure water production apparatus 100 in the present embodiment is configured as a subsystem in ultrapure water production system 100, and if a membrane degassing device or the like is provided on the primary pure water system, the dissolved oxygen concentration in the water to be treated at the inlet of dissolved oxygen removal device 10 is from several μg/L to a dozen μg/L or so. As will become clear from Examples described below, dissolved oxygen can be sufficiently removed in dissolved oxygen removal device 10 in the present embodiment if the water to be treated contains more hydrogen than the equivalent amount of dissolved oxygen. Therefore, if the value of the electric current flowing between anode 11 and cathode 12 is controlled while monitoring the dissolved hydrogen concentration in the water to be treated by dissolved hydrogen concentration meter 51, the dissolved oxygen concentration can be controlled to be less than 1 μg/L while controlling the dissolved hydrogen concentration in the treated water to be less than 1 μg/L. Since the amount of hydrogen that must be generated to remove dissolved oxygen is small, the value of the DC current flowing between anode 11 and cathode 12 can also be reduced. Since the dissolved oxygen concentration and the dissolved hydrogen concentration in the treated water are low, this ultrapure water production system 100 does not require a membrane degassing device to remove dissolved oxygen or the like.

Another example of pure water production apparatus 100 will be described using FIG. 3. In ultrapure water production apparatus 100 shown in FIG. 1, pump 120 installed at the outlet of primary pure water tank 110 supplies ultrapure water to the point of use via pipe 172 while circulating the ultrapure water in ultrapure water production apparatus 100. If the pressure loss between ultrapure water production apparatus 100 and the point of use is large, including the pressure loss due to the height of the location of the point of use, it is necessary to increase the discharge pressure of pump 120. However, if the discharge pressure is increased, anion exchange membranes 32, 34 and cation exchange membranes 31, 33 in dissolved oxygen removal device 10 may be damaged. Therefore, ultrapure water production apparatus 10 shown in FIG. 3 is configured such that, in ultrapure water production apparatus 100 shown in FIG. 1, booster pump 150 that pressurizes and feeds the treated water from dissolved oxygen removal device 10 is installed in the preceding stage of non-regenerative ion exchange device 160. Booster pump 150 prevents damage to anion exchange membranes 32, 34 and cation exchange membranes 31, 33 in dissolved oxygen removal device 10, while increasing the supply capacity of the ultrapure water to the point of use.

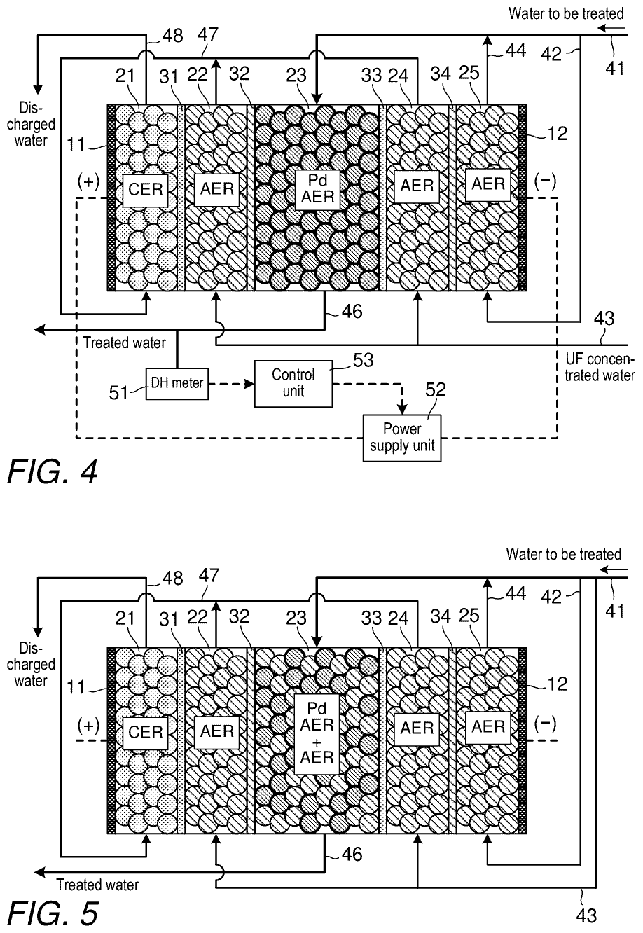

In ultrapure water production apparatuses 100 shown in FIGS. 1 and 3, the configuration of dissolved oxygen removal device 10 is not limited to one shown in FIG. 2, but various configurations are possible. Examples of the configuration of dissolved oxygen removal device 10 are described below using FIGS. 4 to 11. Dissolved oxygen removal devices 10 shown in FIG. 5 and the subsequent drawings differ from dissolved oxygen removal device 10 shown in FIG. 2 only in the configuration of dissolved oxygen removal chamber 23 and the arrangement of dissolved oxygen removal chamber 23 and concentration chambers 22, 24, etc. Therefore, in FIGS. 5 to 11, depictions of dissolved hydrogen concentration meter 51, power supply unit 52 and control device 53 are omitted.

In dissolved oxygen removal device 10 shown in FIG. 2, a portion of the water to be treated is branched and supplied to concentration chambers 22, 24 as concentration chamber supply water, but water other than the water to be treated can be used as the concentration chamber supply water. In dissolved oxygen removal device 10 shown in FIG. 4, UF concentrated water generated in ultrafiltration membrane device 170 in ultrapure water production apparatus 100 is fed into pipe 43 thereby supplying the UF concentrated water to concentration chambers 22, 24 as the concentration chamber supply water.

Dissolved oxygen removal device 10 shown in FIG. 5 is configured such that, in dissolved oxygen removal device shown in FIG. 2, dissolved oxygen removal chamber 23 is filled with a mixture of the Pd-supported anion exchange resin (Pd-AER) and an anion exchange resin without metal catalyst (AER) supported, i.e., in a mixed-bed manner. This configuration can reduce the amount of expensive palladium catalyst used, thus reducing costs.

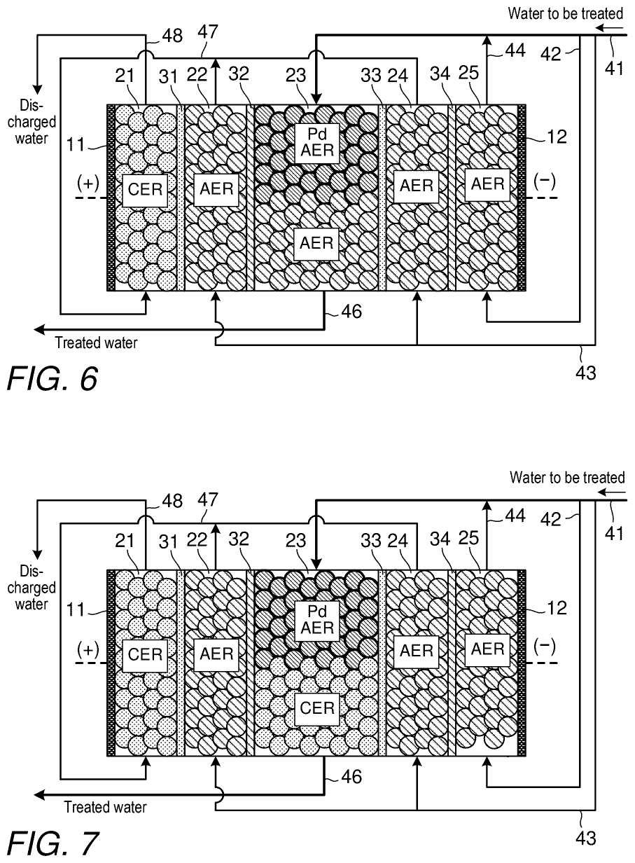

Dissolved oxygen removal device 10 shown in FIG. 6 is similar to dissolved oxygen removal device 10 shown in FIG. 2, but differs from the device shown in FIG. 2 in that dissolved oxygen removal chamber 23 has a double-bed configuration and Pd-supported anion exchange resin is provided only in the upstream portion of the flow in dissolved oxygen removal chamber 23. The downstream portion of the flow in dissolved oxygen removal chamber 23 is filled with an anion exchange resin (AER) without a metal catalyst supported. Since the reaction rate between hydrogen and oxygen in the presence of Pd-supported anion exchange resin is sufficiently large, it is possible to sufficiently remove dissolved oxygen in the water to be treated even when the Pd-supported anion exchange resin is packed in dissolved oxygen removal chamber 23 in a multiple-bed configuration such that the Pd-supported anion exchange resin is placed in a part of dissolved oxygen removal chamber 23. In case that the Pd-supported anion exchange resin is placed in dissolved oxygen removal chamber 23 in a multiple-bed configuration, if there are no ion exchangers other than the Pd-supported anion exchange resin in the area where the Pd-supported anion exchange resin is placed, that is, if the Pd-supported anion exchange resin is placed in a single-bed configuration only in that area, a layer of the Pd-supported anion exchange resin may be paced in any location in dissolved oxygen removal chamber 23. In such a case, it is of course necessary to ensure that no water to be treated flows through dissolved oxygen removal chamber 23 without passing through the layer of the Pd-supported anion exchange resin. In order to prevent the anion exchange resin which does not support metal catalyst from being degraded by hydrogen peroxide, when the Pd-supported anion exchange resin is placed in dissolved oxygen removal chamber 23 in a multiple-bed configuration, the Pd-supported anion exchange resin is preferably placed in the upstream portion of the flow of the water to be treated in dissolved oxygen removal chamber 23. The configuration shown in FIG. 6 also reduces the use of expensive palladium catalysts, thus reducing costs.

Dissolved oxygen removal device 10 shown in FIG. 7 is similar to dissolved oxygen removal device 10 shown in FIG. 6, but differs from the one shown in FIG. 6 in that the ion exchanger filled in the downstream region of dissolved oxygen removal chamber 23, which has a multiple-bed configuration, is not an anion exchange resin without a metal catalyst supported but a cation exchange resin (CER) without a metal catalyst supported.

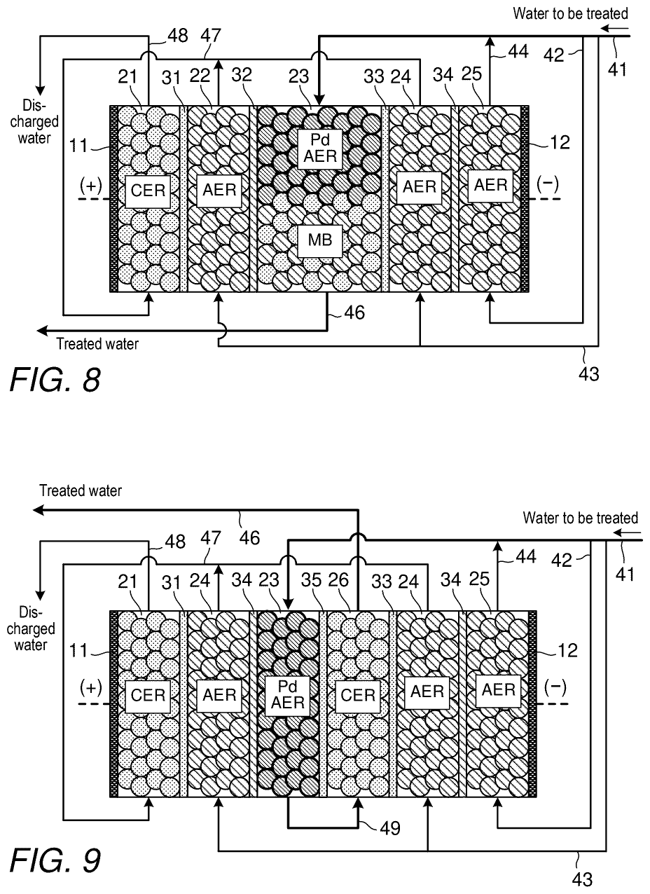

Dissolved oxygen removal device 10 shown in FIG. 8 is similar to dissolved oxygen removal device 10 shown in FIG. 6, but differs from the one shown in FIG. 6 in that an anion exchange resin without a supported metal catalyst and a cation exchange resin without a supported metal catalyst are filled in the downstream region of dissolved oxygen removal chamber 23, which has a multiple-bed configuration, in a mixed-bed configuration (MB).

In dissolved oxygen removal devices 10 shown in FIGS. 2, and 4 to 8, between anode 11 and cathode 12, a deionization chamber can be provided adjacent to dissolved oxygen removal chamber 23 via an intermediate ion exchange membrane on the cathode side or anode side of dissolved oxygen removal chamber 23. In this case, the outlet water from dissolved oxygen removal chamber 23 can be passed through the deionization chamber, or the water to be treated can be passed through the deionization chamber before being fed to dissolved oxygen removal chamber 23. The deionization chamber is filled with an ion exchanger. The intermediate ion exchange membrane can be an anion exchange membrane, a cation exchange membrane, or a composite membrane such as a bipolar membrane. This configuration can enhance the deionization performance in dissolved oxygen removal device 10.

FIG. 9 shows an example of dissolved oxygen removal device 10 in which a deionization chamber is provided adjacent to dissolved oxygen removal chamber 23. Dissolved oxygen removal device 10 shown in FIG. 9 is configured such that, in dissolved oxygen removal device 10 shown in FIG. 2, deionization chamber 26 is placed between dissolved oxygen removal chamber 23 and concentration chamber 24. Dissolved oxygen removal chamber 23 and deionization chamber 26 are partitioned by cation exchange membrane 35 provided therebetween, which is an intermediate ion exchange membrane, and deionization chamber 26 and concentration chamber 24 are partitioned by cation exchange membrane 33 provided therebetween. Deionization chamber 26 is filled with a cation exchange resin. The water to be treated with which the outlet water from cathode chamber 25 is merged is introduced into dissolved oxygen removal chamber 23 via pipe 41, the outlet water from dissolved oxygen removal chamber 23 is supplied to deionization chamber 26 via pipe 49, and the treated water from which dissolved oxygen is removed and which is subjected to deionization treatment flows out of deionization chamber 26 via pipe 46. Although deionization chamber 26 is filled with a cation exchange resin in a single-bed configuration in the example shown in FIG. 9, the packing configuration of ion exchange resins in deionization chamber 26 is not limited to this configuration. For example, deionization chamber 26 may be filled with an anion exchange resin and a cation exchange resin in a mixed-bed configuration, or it may be filled with an anion exchange resin and a cation exchange resin in a multiple-bed configuration so that a layer of the cation exchange resin is placed at the upstream portion. When deionization chamber 26 is filled with an anion exchange resin and a cation exchange resin in a mixed-bed or multiple-bed configuration, an anion exchange membrane is used as the intermediate ion exchange membrane that separates dissolved oxygen removal chamber 23 and deionization chamber 26.

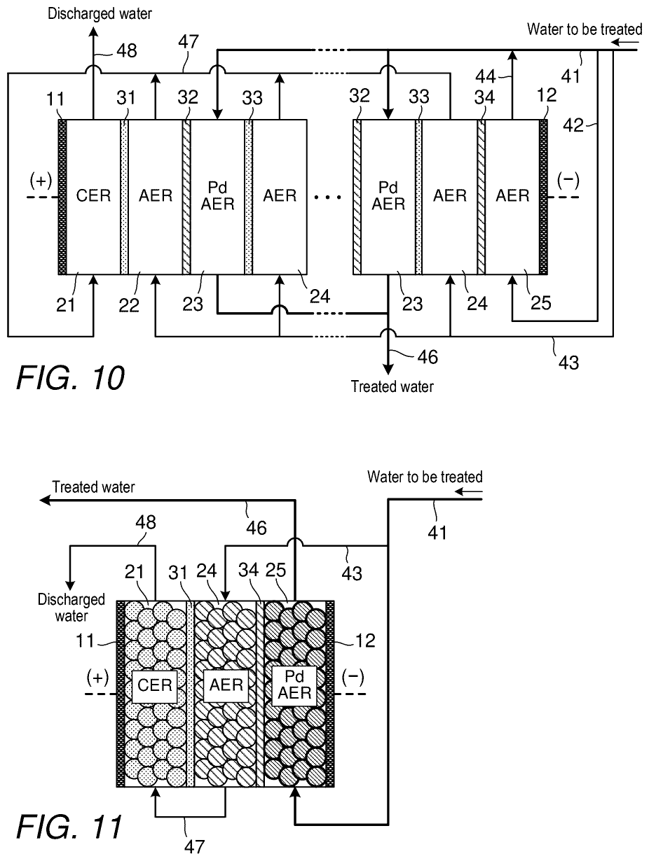

Dissolved oxygen removal devices 10 shown in FIGS. 2, and 4 to 9 have the same configuration as a general EDI device, except that the deionization chamber in an EDI device is made dissolved oxygen removal chamber 23, and dissolved oxygen is also removed in dissolved oxygen removal chamber 23. In a general EDI device, a plurality of deionization chambers can be placed between the anode and cathode. Also in dissolved oxygen removal devices 10 shown in FIGS. 2, and 4 to 9, the configuration consisting of anion exchange membrane 32, dissolved oxygen removal chamber 23, cation exchange membrane 33, and concentration chamber 24 is assumed as a repeating unit, and multiple of these repeating units are placed between concentration chamber 22 adjacent to anode chamber 21 and anion exchange membrane 34 partitioning cathode chamber 25 so that a plurality of dissolved oxygen removal chambers 23 can be arranged between anode 11 and cathode 12. Dissolved oxygen removal device 10 shown in FIG. 10 is configured such that, in dissolved oxygen removal device 10 shown in FIG. 2, a plurality of dissolved oxygen removal chambers 23 are arranged. The water to be treated to which the outlet water from cathode chamber 25 is added is distributed via pipe 41 in parallel to and passes through the plurality of dissolved oxygen removal chambers 23. The treated water from which dissolved oxygen is removed is discharged from each of dissolved oxygen removal chambers 23.

Furthermore, in the ultrapure water production apparatus according to the present invention, cathode chamber 25 itself can function as dissolved oxygen removal chamber 13 in dissolved oxygen removal device 10. In this case, it is no longer necessary to provide a dissolved oxygen removal chamber separated from the cathode chamber. FIG. 11 shows dissolved oxygen removal device 10 in which the cathode chamber itself is made the dissolved oxygen removal chamber. Dissolved oxygen removal device shown in FIG. 11 is equipped with: anode chamber 21 in which anode 11 is provided; concentration chamber 24 separated from anode chamber 21 by cation exchange membrane 31; and cathode chamber 25 in which cathode 12 is provided and which is separated from concentration chamber 24 by anion exchange membrane 34. Anode chamber 21 is filled with a cation exchange resin and concentration chamber 24 is filled with an anion exchange resin. Cathode chamber 25 is filled with a Pd-supported anion exchange resin in a single-bed manner. Water to be treated containing dissolved oxygen is supplied to cathode chamber 25 via pipe 41 and the water to be treated passes through cathode chamber 25. The water to be treated is supplied to concentration chamber 24 by pipe 43, which is branched from pipe 41, and the outlet water of concentration chamber 24 is supplied as is to anode chamber 21 via pipe 47. The outlet water anode chamber 21 is discharged outside via pipe 48 as waste water.

In dissolved oxygen removal device 10 shown in FIG. 11, a DC current is applied between anode 11 and cathode 12, and the water to be treated is supplied to concentration chamber 24 and cathode chamber 25. In cathode chamber 25, the DC current causes a cathodic reaction to proceed on the surface of cathode 12, generating hydrogen. This hydrogen reacts with dissolved oxygen in the water to be treated on the surface of the Pd-supported anion exchange resin to generate water. The dissolved oxygen in the water to be treated decreases to the extent that it reacts with hydrogen. As a result, treated water in which dissolved oxygen is sufficiently removed is discharged from cathode chamber 25. Since dissolved oxygen is removed if hydrogen is present in cathode chamber 25, the application of DC current between anode 11 and cathode 12 can be intermittent in consideration of the residence time of the water to be treated in cathode chamber 25. More specifically, while the DC current is applied continuously or intermittently, the flow of the water to be treated into dissolved oxygen removal chamber 23 may also be done intermittently.

Since the Pd-supported anion exchange resin is an anion exchanger, anions in the water to be treated are captured by the Pd-supported anion exchange resin. Since the cathodic reaction at cathode 12 also generates hydroxide ions (OH⁻), the anions captured in the Pd-supported anion exchange resin are ion-exchanged by the hydroxide ions and then released, and moved by the electric field between anode 11 and cathode 12 through anion exchange membrane 34 to concentration chamber 24. The anions that have moved to concentration chamber 24 are then discharged to the outside of the device through anode chamber 21 on the flow of the feed water in concentration chamber 24. In other words, in dissolved oxygen removal device 10 shown in FIG. 11, cathode chamber 25 also performs deionization treatment for anions. The Pd-supported anion exchange resin can also decompose hydrogen peroxide, so dissolved oxygen removal device 10 shown in FIG. 11 can also remove hydrogen peroxide from the water to be treated in the same way as dissolved oxygen removal device 10 described above.

FIG. 2 and FIGS. 4 to 11 above describe dissolved oxygen removal devices 10, which are oxidizing substance material removal devices. Since dissolved oxygen removal device 10 has a structure as an EDI device as described above, the direction of water flow in each chamber (i.e., anode chamber 21, concentration chambers 22, 24, dissolved oxygen removal chamber 23, cathode chamber 25, and deionization chamber 26), as in general EDI devices, is not limited to the directions described in each of FIGS. 2, and 4 to 11. For example, the water flow in dissolved oxygen removal chamber 23 and the adjacent concentration chambers 22, 24 may be in a parallel flow relationship. Instead of supplying the outlet water of concentration chambers 22, 24 to anode chamber 21, the water flow may be parallel to anode chamber 21 and concentration chambers 22, 24.

Furthermore, in each of dissolved oxygen removal devices 10 described above, the ion exchange resin filled in concentration chambers 22, 24 is not limited to an anion exchange resin. In at least one of concentration chambers 22, 24 constituting dissolved oxygen removal device 10, an anion exchange resin and a cation exchange resin may be filled in a mixed-bed or multiple-bed configuration. The ion exchange membrane, i.e., cation exchange membrane 31, partitioning anode chamber 21 and concentration chamber 22 adjacent thereto may be removed, and concentration chamber 22 itself may be configured to function as anode chamber 21. Similarly, the ion exchange membrane, i.e., anion exchange membrane 34, partitioning cathode chamber 25 and the adjacent concentration chamber 24 can be removed, and concentration chamber 24 itself can be configured to function as cathode chamber 25.

### EXAMPLES

The present invention will be described in more detail below based on examples.

### Example 1

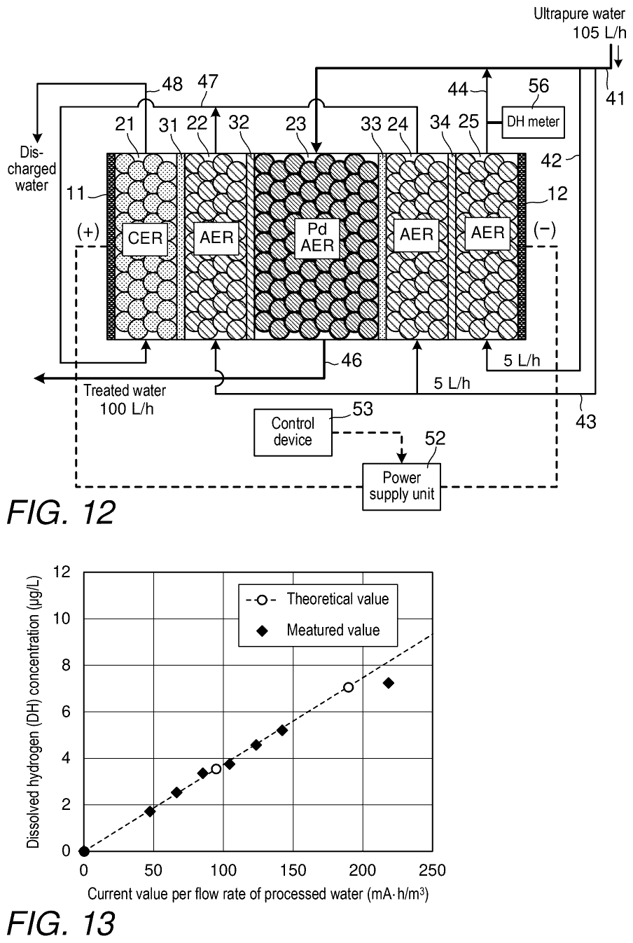

The dissolved oxygen removal device shown in FIG. 12 was assembled. The dissolved oxygen removal device shown in FIG. 12 was configured such that, in dissolved oxygen removal device 10 shown in FIG. 2, dissolved hydrogen meter 51 that measures the dissolved hydrogen concentration of the treated water was removed, and instead, dissolved hydrogen concentration meter (DH meter) 56 that is connected to pipe 44 to measure the dissolved hydrogen concentration of the outlet water of cathode chamber 25 was installed. Ultrapure water was used as the water to be treated, and the ultrapure water was supplied to the dissolved oxygen removal device via pipe 41 at a flow rate of 105 L/h. The supplied water to be treated was branched and flowed to cathode chamber 25 at a flow rate of 5 L/h and to concentration chambers 22, 24 at a total flow rate of 5 L/h. Since the outlet water from cathode chamber 25 merges with the water to be treated flowing through pipe 41, the flow rate of the treated water flowing out of dissolved oxygen removal device 23 is 100 L/h.

Control device 53 controlled power supply unit 52 to gradually increase the DC current value applied between anode 11 and cathode 12, and the dissolved hydrogen concentration in the outlet water of cathode chamber 25 was measured by dissolved hydrogen concentration meter (DH meter) 56. The results are shown in FIG. 13. The horizontal axis of FIG. 13 indicates the value of the applied current per flow rate of the treated water flowing out of dissolved oxygen removal chamber 23. Since the amount of hydrogen generated by the water dissociation reaction occurring in cathode chamber 25 is theoretically calculated from the applied current value, so the calculated value is shown in FIG. 13 as the theoretical value. As shown in FIG. 13, the measured dissolved hydrogen concentration agrees well with the theoretical value, especially on the lower current side. It was found that the dissolved hydrogen concentration in the water to be treated supplied to dissolved oxygen removal chamber 23 can be controlled even in the lower concentration range of less than 10 μg/L by controlling the DC current value applied between anode 11 and cathode 12. This means that the amount of hydrogen just necessary to remove dissolved oxygen contained in the water to be treated can be added. It was also found that the concentration of dissolved hydrogen in the treated water flowing out of dissolved oxygen removal chamber 23 can also be controlled.

### Example 2

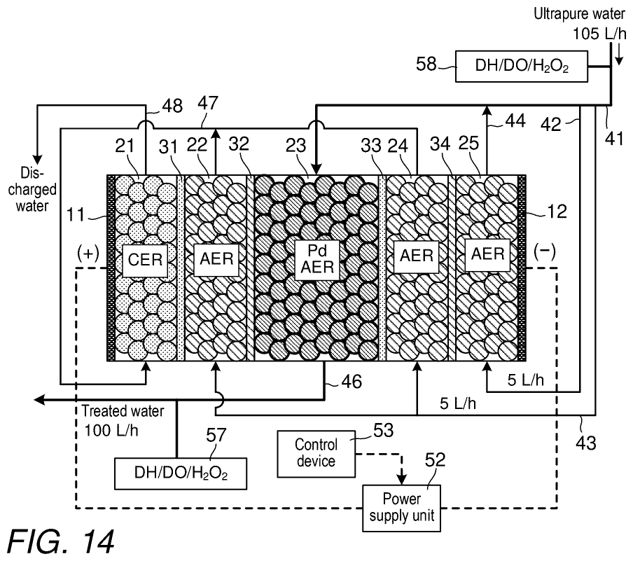

The dissolved oxygen removal device shown in FIG. 14 was assembled. The dissolved oxygen removal device shown in FIG. 14 was configured such that, in the dissolved oxygen removal device 10 shown in FIG. 2, dissolved hydrogen concentration meter 51 which measures the dissolved hydrogen concentration of the treated water was removed, and instead, measuring device 57 connected to pipe 46 was provided for measuring concentrations of dissolved hydrogen, dissolved oxygen (DO), and hydrogen peroxide (H₂O₂) in the treated water, and measuring device 58 connected to pipe 41 was also provided for measuring concentrations of dissolved hydrogen, dissolved oxygen, and hydrogen peroxide in the water to be treated supplied to the dissolved oxygen removal device. The water to be treated was supplied to the dissolved oxygen removal device via pipe 41 at a flow rate of 105 L/h. A portion of the supplied water to be treated was branched and flowed to cathode chamber 25 at a flow rate of 5 L/h, and also to concentration chambers 22, 24 at a total flow rate of 5 L/h. Since the outlet water from cathode chamber 25 merges with the water to be treated flowing through pipe 41, the flow rate of the treated water flowing out of dissolved oxygen removal device 23 is 100 L/h.

Two types of water to be treated were used as the water to be treated: ultrapure water without hydrogen peroxide added, and ultrapure water with hydrogen peroxide added. For each type of the water to be treated, the concentrations of dissolved hydrogen, dissolved oxygen, and hydrogen peroxide in the treated water were measured by gradually increasing the DC current applied between anode 11 and cathode 12 while feeding the water to be treated to the dissolved oxygen removal device. When ultrapure water without hydrogen peroxide added was used as the water to be treated, the concentrations of dissolved hydrogen, dissolved oxygen, and hydrogen peroxide in the water to be treated were as shown in Table 1, and the concentrations of dissolved hydrogen, dissolved oxygen, and hydrogen peroxide in the treated water at each applied current value per flow rate of the treated water are shown in Table 2.

TABLE 1

| | Water to |
|---|---|
| | be treated |
| Dissolved hydrogen concentration (μg/L) | <1 |
| Dissolved oxygen concentration (μg/L) | 15 |
| Hydrogen peroxide concentration (μg/L) | 15 |

TABLE 2

| | Treated water | | |
|---|---|---|---|
| Current value | Dissolved | Dissolved | Hydrogen |
| per flow rate of | hydrogen | oxygen | peroxide |
| treated water | concentration | concentration | concentration |
| (mA · h/m³) | (μg/L) | (μg/L) | (μg/L) |
| 0 | <1 | 19 | <1 |
| 47 | <1 | 10 | <1 |
| 66 | <1 | 5 | <1 |
| 85 | <1 | <1 | <1 |
| 104 | 1 | <1 | <1 |
| 123 | 3 | <1 | <1 |

When ultrapure water with hydrogen peroxide added was used as the water to be treated, the concentrations of dissolved hydrogen, dissolved oxygen, and hydrogen peroxide in the water to be treated were as shown in Table 3. The concentrations of dissolved hydrogen, dissolved oxygen, and hydrogen peroxide in the treated water at each applied current value per flow rate of the treated water were shown in Table 4.

TABLE 3

| | Water to |
|---|---|
| | be treated |
| Dissolved hydrogen concentration (μg/L) | <1 |
| Dissolved oxygen concentration (μg/L) | 17 |
| Hydrogen peroxide concentration (μg/L) | 188 |

TABLE 4

| | Treated water | | |
|---|---|---|---|
| Current value | Dissolved | Dissolved | Hydrogen |
| per flow rate of | hydrogen | oxygen | peroxide |
| treated water | concentration | concentration | concentration |
| (mA · h/m³) | (μg/L) | (μg/L) | (μg/L) |
| 0 | <1 | 102 | <1 |
| 95 | <1 | 79 | <1 |
| 190 | <1 | 55 | <1 |
| 285 | <1 | 21 | <1 |
| 380 | <1 | <1 | <1 |
| 474 | 3 | <1 | <1 |
| 569 | 5 | <1 | <1 |

From the results shown in Tables 1 to 4, it was found that, regardless of the addition of hydrogen peroxide, increasing the current value of the DC current applied between anode 11 and cathode 12 decreases the dissolved oxygen concentration of the treated water, and the dissolved oxygen concentration can be reduced to less than 1 μg/L. It was also found that after the concentration of dissolved oxygen becomes less than 1 μg/L, the concentration of dissolved hydrogen becomes more than 1 μg/L by further increasing the current value. In other words, in the dissolved oxygen removal device used in the ultrapure water production apparatus based on the present invention, for example, dissolved oxygen removal device 10 shown in FIG. 2, as shown in the cases of the current values of 85 mA·h/m³ in Table 2 and 380 mA·h/m³ in Table 4, both the dissolved oxygen and dissolved hydrogen concentrations in the treated water could be maintained below 1 μg/L by increasing the current value applied between anode 11 and cathode 12 within the range in which the dissolved hydrogen concentration of the treated water does not reach 1 μg/L or mote. It was also found that the hydrogen peroxide concentration could also be kept below 1 μg/L. The reason why the current value required to keep the dissolved oxygen concentration below 1 μg/L in the case of Table 4 is higher than that in the case of Table 2 is that hydrogen is also required to remove hydrogen peroxide.

### Reference Signs List

10 Dissolved oxygen removal device;
11 Anode;
12 Cathode;
21 Anode chamber;
22, 24 Concentration chamber;
23 Dissolved oxygen removal chamber;
25 Cathode chamber;
26 Deionization chamber;
31, 33, 35 Cation exchange membrane;
32, 34 Anion exchange membrane;
100 Ultrapure water production apparatus;
110 Primary pure water tank;
130 Pump;
140 Ultraviolet irradiation device;
150 Booster pump;
160 Non-regenerative ion exchange device; and
170 Ultrafiltration membrane device.

1. An ultrapure water production apparatus that sequentially treats water to be treated to produce ultrapure water, comprising:
a receiving unit that accepts the water to be treated;
a first pump connected to an outlet of the receiving unit to feed the water to be treated;
an ultraviolet irradiation device that is installed at a secondary side of the first pump, and irradiates the water to be treated with ultraviolet light to perform ultraviolet oxidation treatment;
an oxidizing substance removal device that is installed at a subsequent stage of the ultraviolet irradiation device and removes at least oxidizing substances contained in the water to be treated; and
a second pump installed at a subsequent stage of the oxidizing substance removal device to feed outlet water of the oxidizing substance removal device,
wherein at least a portion of ultrapure water produced is circulated to the receiving unit,
wherein the oxidizing substance removal device comprises:
an anode and a cathode;
a dissolved oxygen removal chamber which is positioned between the anode and the cathode, and filled with an ion exchanger, and through which the water to be treated passes; and
a power supply unit that applies a DC current between the anode and the cathode, and
wherein at least a portion of the ion exchanger filled in the dissolved oxygen removal chamber is an ion exchanger on which a metal catalyst is supported.

2. The ultrapure water production apparatus according to claim 1, further comprising:
a measuring means for measuring a concentration of dissolved hydrogen in treated water discharged from the dissolved oxygen removal chamber; and
a control device that controls a hydrogen concentration in the water to be treated introduced into the dissolved oxygen removal chamber based on a measured value taken by the measuring means.

3. The ultrapure water production apparatus according to claim 2, wherein the control device controls the power supply unit to vary a value of current applied between the anode and the cathode.

4. The ultrapure water production apparatus according to claim 3,
wherein the oxidizing substance removal device is equipped with a cathode chamber in which the cathode is provided, and
wherein at least a portion of the water to be treated that passes through the oxidizing substance removal device is water to be treated that has passed through the cathode chamber.

5. The ultrapure water production apparatus according to claim 4, further comprising an ultrafiltration membrane device installed at a subsequent stage of the oxidizing substance removal device,
wherein the oxidizing substance removal device includes: at least one concentration chamber adjacent to the dissolved oxygen removal chamber; and an anode chamber in which the anode is provided, and
wherein concentrated water discharged from the ultrafiltration membrane device is supplied to the concentration chamber and the anode chamber.

6. The ultrapure water production apparatus according to claim 5, wherein the dissolved oxygen removal chamber is partitioned by at least one of an electrode plate that is the anode, an electrode plate that is the cathode, and an ion exchange membrane.

7. An ultrapure water production method for producing ultrapure water by sequentially treating water to be treated, comprising:
a first pressurization to pressurize and feed the water to be treated;
an ultraviolet irradiation to irradiate the water to be treated which is fed by the first pressurization with ultraviolet light to perform ultraviolet oxidation treatment;
an oxidizing substance removal to remove at least oxidizing substances contained in outlet water during the ultraviolet irradiation;
a second pressurization to pressurize and feed outlet water during the oxidizing substance removal; and
circulating at least a portion of produced ultrapure water to a preceding stage of the ultraviolet irradiation,
wherein the oxidizing substance removal comprises:
applying a DC current between the anode and cathode; and
passing the water to be treated through a dissolved oxygen removal chamber, which is located between the anode and the cathode and filled with an ion exchanger, and
wherein at least a portion of the ion exchanger filled in the dissolved oxygen removal chamber is an ion exchanger on which a metal catalyst is supported.

8. The ultrapure water production method according to claim 7, wherein a dissolved hydrogen concentration of treated water flowing out of the dissolved oxygen removal chamber is measured, and a value of current applied between the anode and the cathode is controlled according to the dissolved hydrogen concentration measured.

9. The ultrapure water production method according to claim 7, wherein at least a portion of the water to be treated that passes through the dissolved oxygen removal chamber is water to be treated that has passed through a cathode chamber in which the cathode is provided.

10. The ultrapure water production method according to claim 8, wherein at least a portion of the water to be treated that passes through the dissolved oxygen removal chamber is water to be treated that has passed through a cathode chamber in which the cathode is provided.
